(19) United States
(12) Patent Application Publication
(10) Pub. No.: US 2022/0123879 A1
(43) Pub. Date: Apr. 21, 2022

(54) SYSTEM AND METHOD TO ALLOCATE POSITIONING REFERENCE SIGNALS IN A COMMUNICATION SYSTEM

(71) Applicant: TELEFONAKTIEBOLAGET LM ERICSSON (PUBL), Stockholm (SE)

(72) Inventors: Florent MUNIER, VÄSTRA FRÖLUNDA (SE); Iana SIOMINA, TÄBY (SE)

(21) Appl. No.: 17/424,710

(22) PCT Filed: Feb. 7, 2020
(86) PCT No.: PCT/IB2020/050981

§ 371 Date: Jul. 21, 2021

Related U.S. Application Data
(60) Provisional application No. 62/806,501, filed on Feb. 15, 2019.

(51) Int. Cl. H04L 5/00; H04W 64/00; H04W 56/00

(52) U.S. Cl. CPC H04L 5/005; H04W 56/001; H04W 64/00; H04L 5/0091

(57) ABSTRACT

Systems and methods for obtaining positioning reference signal (PRS) symbols and synchronization signal block (SSB) transmissions in a wireless communication system are disclosed. An example method performed by a wireless device in a wireless communication network includes obtaining PRS configuration information for a plurality of PRS symbols and SSB configuration information for an SSB transmission. The method further includes determining, based on the obtained PRS and SSB configuration information, whether at least one of the plurality of PRS symbols collides with the SSB transmission, and adapting receive circuitry of the wireless device to receive the SSB transmission if the at least one PRS symbol collides with the SSB transmission.

### RELATED APPLICATION

The present application claims the benefit of and priority to U.S. Provisional Patent Application No. 62/806,501 filed Feb. 15, 2019, entitled “SYSTEM AND METHOD TO ALLOCATE POSITIONING REFERENCE SIGNALS IN A COMMUNICATION SYSTEM,” the disclosure of which is hereby incorporated herein by reference in its entirety.

### TECHNICAL FIELD

The present disclosure is directed, in general, to the communication systems and, more specifically, to a system and method for allocating positioning reference signals in a communication system.

### BACKGROUND

Positioning has been a topic in Third Generation Partnership Program (“3GPP”) Long Term Evolution (“LTE”) standardization since 3GPP Release 9. The primary objective is to fulfill regulatory requirements for emergency call positioning. In the legacy LTE standards, the control region or physical downlink control channel (“PDCCH”)/physical control format indicator channel (“PCFICH”)/physical hybrid-ARQ (automatic repeat request) indicator channel (“PHICH”) is designed to be limited to a very specific part of the subframe (typically 1-3 symbols in the beginning of any downlink (“DL”) subframe). The positioning reference signal (“PRS”) pattern is then designed to fit into the data region of the subframe.

In new radio (“NR”) communication systems, the physical downlink control channel is responsible for sending downlink control information (“DCI”) to the user equipment (“UE”) from the gNodeB. Such information includes hybrid automatic repeat request (“HARQ”) feedback, uplink grants, downlink scheduling of the physical downlink shared channel (“PDSCH”), and more. What has not been adequately addressed in communication systems such as NR communication systems is how to manage collisions with the positioning reference signals. The objective is that such positioning reference signals should not be in conflict with other signals and should have priority. The system and method as described herein addresses such conflicts with positioning reference signals in a communication system.

### SUMMARY

These and other problems are generally solved or circumvented, and technical advantages are generally achieved, by advantageous embodiments of the present disclosure for a system and method for allocating positioning reference signals in a communication system to reduce collisions with control channels and/or other communication blocks.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for operating a wireless device in a wireless communications network, said method including the steps of: obtaining PRS configuration information for a plurality of PRS symbols. The method also includes obtaining SSB configuration information for an SSB transmission; determining, based on the received PRS and SSB configuration information, whether at least one of the PRS symbols collides with the SSB transmission. The method also includes adapting receive circuitry of the wireless device to receive the SSB transmission if the at least one PRS symbol collides with the SSB transmission. Other embodiments of this aspect include corresponding computer systems, apparatus, and computer programs recorded on one or more computer storage devices, each configured to perform the actions of the methods.

Implementations may include one or more of the following features: at least one of the plurality of PRS symbols corresponds to the same cell as the SSB transmission; the SSB transmission and at least one of the plurality of PRS symbols correspond to different cells; the wireless device obtains at least one of the PRS configuration information and the SSB configuration information from a location server and/or base station transmission point in the wireless communication network; the SSB configuration information includes one or more of a periodicity parameter and an offset parameter; the wireless device determines that the at least one PRS symbol collides with the SSB transmission when a resource element mapped to by the at least one PRS symbol at least partially overlaps in time or is separated in time by less than a threshold amount from a resource element mapped to by the SSB transmission; the SSB configuration information is obtained in response to a request transmitted from the wireless device to a location server, where the request indicates whether and/or what SSB configuration information is needed by the wireless device; the SSB transmission and the at least one PRS symbol are defined by the SSB and PRS configuration information, respectively, as being mapped to a subcarrier that is not used by the wireless device for mobility measurements; the PRS configuration information defines a region in which the plurality of PRS symbols are to be transmitted by a base station and/or a region in which the plurality of PRS symbols are not to be transmitted by the base station. The method may further include obtaining a positioning measurement using the SSB transmission and reporting the positioning measurement to a base station or a location server. Implementations of the described techniques may include hardware, a method or process, or computer software on a computer-accessible medium.

Another general aspect includes a method in a base station of a wireless communications network, said method including the steps of: obtaining PRS configuration information for a plurality of PRS symbols. The method also includes obtaining SSB configuration information for an SSB transmission; determining, based on the obtained PRS and SSB configuration information, whether at least one of the PRS symbols collides with the SSB transmission. The method also includes transmitting the SSB transmission instead of the at least one PRS symbol if the at least one PRS symbol collides with the SSB transmission. Other embodiments of this aspect include corresponding computer systems, apparatus, and computer programs recorded on one or more computer storage devices, each configured to perform the actions of the methods.

Another general aspect includes a method in a positioning server of a wireless communications network for locating a user equipment (JE), said method including the steps of: receiving, from each of a serving cell for said UE and at least one non-serving cell within range of said UE, a positioning reference signal (PRS) configuration, each PRS configuration defining a region in which PRS symbols are to be transmitted by said serving cell and said at least one non-serving cell; combining said PRS configurations from said serving cell and said at least one non-serving radio cell into a composite PRS report; communicating said composite PRS report to a UE to be positioned, said composite PRS report to be utilized by said UE to obtain measurements for at least some said PRS symbols corresponding to said serving cell, except for any which collide with a synchronization signal block (SSB) associated with said serving cell, and for at least some of said PRS symbols corresponding to said at least one non-serving cell; and, receiving, from said UE, a report of said PRS measurements, said PRS measurements used by said positioning server to estimate the physical location of said UE. Other embodiments of this aspect include corresponding computer systems, apparatus, and computer programs recorded on one or more computer storage devices, each configured to perform the actions of the methods.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, reference is now made to the following descriptions taken in conjunction with the accompanying drawings, in which:

FIG. 1 is a diagram illustrating a wireless communication network that includes one or more wireless devices that communicate with one or more base stations;

FIG. 2 is a diagram illustrating a wireless device operable in a wireless communication network;

FIG. 3 is a diagram illustrating a base station operable in a wireless communication network;

FIG. 4 is a system level diagram illustrating an embodiment of a wireless communication network;

FIG. 5 is a diagram illustrating various arrangements of radio access and core network nodes in a wireless communication network;

illustrate diagrams of embodiments of communication systems;

FIG. 6 is a graphical illustration of a telecommunication network connected via an intermediate network to a host computer in accordance with some embodiments;

FIG. 7 is a graphical illustration of a host computer communicating via a base station with a user equipment over a partially wireless connection in accordance with some embodiments;

FIG. 8 is a diagram illustrating an NR and LTE wireless communication network architecture that facilitates positioning of wireless devices;

FIG. 9 illustrates a block diagram of an embodiment of a positioning reference signal pattern;

FIG. 10 illustrates block diagram of embodiments of PRS regions;

FIG. 11 illustrates a block diagram of an embodiment of a CORESET gap configuration;

FIG. 12 is a flowchart illustrating a method of operating a wireless device; and

FIG. 13 is a flowchart illustrating a method of operating a base station.

Corresponding numerals and symbols in the different figures generally refer to corresponding parts unless otherwise indicated, and may not be redescribed in the interest of brevity after the first instance. The FIGURES are drawn to illustrate the relevant aspects of exemplary embodiments.

### DETAILED DESCRIPTION

The making and using of the present exemplary embodiments are discussed in detail below. It should be appreciated, however, that the embodiments provide many applicable inventive concepts that can be embodied in a wide variety of specific contexts. The specific embodiments discussed are merely illustrative of specific ways to make and use the systems, subsystems, and modules for managing colliding channels in a communication system with positioning reference signals. While the principles will be described in the environment of a Third Generation Partnership Program (“3GPP”) Long Term Evolution (“LTE”) and/or Fifth Generation (“5G”) communication system, any environment such as a Wi-Fi wireless communication system is well within the broad scope of the present disclosure.

In some embodiments, a non-limiting term user equipment (“UE”) is used. The user equipment can be any type of wireless communication device—with or without an active user—capable of communicating with a network node or another user equipment over radio signals. The user equipment may be any device that has an addressable interface (e.g., an Internet protocol (“IP”) address, a Bluetooth identifier (“ID”), a near-field communication (“NFC”) ID, etc.), a cell radio network temporary identifier (“C-RNTI”), and/or is intended for accessing services via an access network and configured to communicate over the access network via the addressable interface. The user equipment may include, without limitation, a radio communication device, a target device, a device to device (“D2D”) user equipment, a machine type user equipment or user equipment capable of machine to machine communication (“M2M”), a sensor device, meter, vehicle, household appliance, medical appliance, media player, camera, a personal computer (“PC”), a tablet, a mobile terminal, a smart phone, a laptop embedded equipment (“LEE”), a laptop mounted equipment (“LME”), a universal serial bus (“USB”) dongle, and customer premises equipment (“CPE”).

Also, in some embodiments, generic terminology “network node” is used. It can be any kind of network node that may include a radio network node such as base station, radio base station, base transceiver station, base station controller, network controller, multi-standard radio base station, g Node B (“gNB”), new radio (“NR”) base station, evolved Node B (“eNB”), Node B, multi-cell/multicast coordination entity (“MCE”), relay node, access point, radio access point, remote radio unit (“RRU”) remote radio head (“RRH”), a multi-standard radio base station (“MSR BS”), a core network node (e.g., mobility management entity (“MME”), self-organizing network (“SON”) node, a coordinating node, positioning node, minimization of drive test (“MDT”) node, etc.), or even an external node (e.g., third party node, a node external to the current network), etc. The network node may also include test equipment. The term “radio node” used herein may be used to denote a user equipment or a radio network node. These various nodes will be introduced herein below.

The term “signaling” used herein may include, without limitation, high-layer signaling (e.g., via radio resource control (“RRC”) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “radio signal measurement” used herein may refer to any measurement performed on radio signals. The radio signal measurements can be absolute or relative. The radio signal measurement may be called as signal level that may be signal quality and/or signal strength. The radio signal measurements can be, for instance, intra-frequency, inter-frequency, inter-radio access technology (“RAT”) measurements, carrier aggregation (“CA”) measurements. The radio signal measurements can be unidirectional (e.g., downlink (“DL”) or uplink (“UL”)) or bidirectional (e.g., round trip time (“RTT”), Rx-Tx, etc.). Some examples of radio signal measurements include timing measurements (e.g., time of arrival (“TOA”), timing advance, round trip time (“RTT”), reference signal time difference (“RSTD”), Rx-Tx, propagation delay, etc.), angle measurements (e.g., angle of arrival), power-based measurements (e.g., received signal power, reference signal received power (“RSRP”), received signal quality, reference signal received quality (“RSRQ”), signal-to-interference-plus-noise ratio (“SINR”), signal-to-noise ratio (“SNR”), interference power, total interference plus noise, received signal strength indicator (“RSSI”), noise power, etc.), cell detection or cell identification, radio link monitoring (“RLM”), and system information (“SI”) reading, etc. The inter-frequency and inter-RAT measurements may be carried out by the user equipment in measurement gaps unless the user equipment is capable of doing such measurement without gaps. Examples of measurement gaps are measurement gap id #0 (each gap of six milliseconds (“ms”) occurring every 40 ms), measurement gap id #1 (each gap of six ms occurring every 80 ms), etc. The measurement gaps maybe configured by the network node for the user equipment.

Performing a measurement on a carrier may imply performing measurements on signals of one or more cells operating on that carrier or performing measurements on signals of the carrier (a carrier specific measurement such as RSSI). Examples of cell specific measurements are signal strength, signal quality, etc.

The term measurement performance may refer to any criteria or metric that characterizes the performance of the measurement performed by a radio node. The term measurement performance is also called as measurement requirement, measurement performance requirements, etc. The radio node meets one or more measurement performance criteria related to the performed measurement. Examples of measurement performance criteria are measurement time, number of cells to be measured with the measurement time, measurement reporting delay, measurement accuracy, measurement accuracy with respect to a reference value (e.g., ideal measurement result), etc. Examples of measurement time are measurement period, cell identification period, evaluation period, etc.

The embodiments described herein may be applied to any multicarrier system wherein at least two radio network nodes can configure radio signal measurements for the same user equipment. One specific example scenario includes a dual connectivity deployment with LTE primary cell (“PCell”) and NR primary secondary cell (“PSCell”). Another example scenario is a dual connectivity deployment with NR PCell and NR PSCell.

The term time resource used herein may correspond to any type of physical resource or radio resource expressed in terms of length of time. Examples of time resources are, without limitation, symbol, mini-slot, time slot, subframe, radio frame, transmission time interval (“TTI”), and interleaving time. The term TTI used herein may correspond to any time period over which a physical channel can be encoded and interleaved for transmission. The physical channel is decoded by the receiver over the same time period (TO) over which it was encoded. The TTI may also interchangeably called as short TTI (sTTI), transmission time, slot, sub-slot, mini-slot, short subframe (SSF) and mini-subframe. The embodiments described herein may apply to any radio resource control (“RRC”) state such as RRC_CONNECTED or RRC_IDLE.

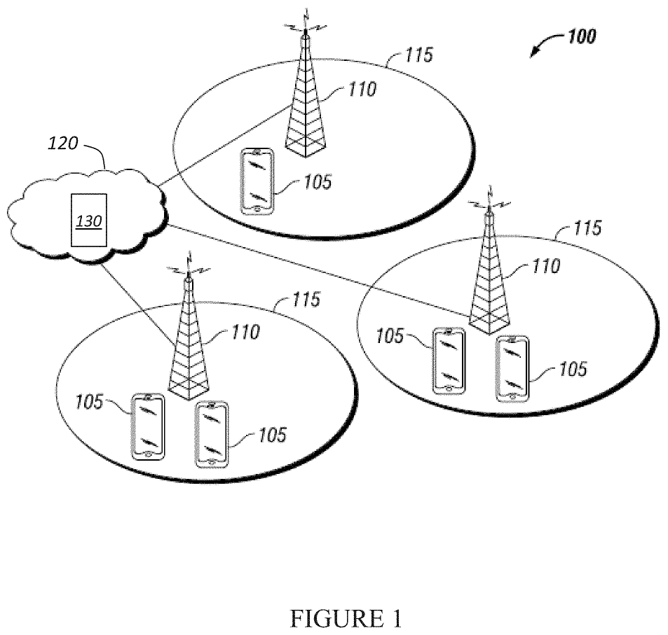

Referring initially to FIGS. 1 to 3, illustrated are diagrams of embodiments of a communication system 100, and portions thereof. As shown in FIG. 1, the communication system 100 includes one or more instances of user equipment (generally designated 105) in communication with one or more radio access nodes (generally designated 110). The communication network 100 is organized into cells 115 that are connected to a core network 120 via corresponding radio access nodes 110. In particular embodiments, the communication system 100 may be configured to operate according to specific standards or other types of predefined rules or procedures. Thus, particular embodiments of the communication system 100 may implement communication standards, such as Global System for Mobile Communications (“GSM”), Universal Mobile Telecommunications System (“UMTS”), Long Term Evolution (“LTE”), and/or other suitable 2G, 3G, 4G, or 5G standards; wireless local area network (“WLAN”) standards, such as the IEEE 802.11 standards; and/or any other appropriate wireless communication standard, such as the Worldwide Interoperability for Microwave Access (“WiMax”), Bluetooth, and/or ZigBee standards.

In addition to the devices mentioned above, the user equipment 105 may be a portable, pocket-storable, hand-held, computer-comprised, or vehicle-mounted mobile device, enabled to communicate voice and/or data, via a wireless or wireline connection. A user equipment 105 may have functionality for performing monitoring, controlling, measuring, recording, etc., that can be embedded in and/or controlled/monitored by a processor, central processing unit (“CPU”), microprocessor, ASIC, or the like, and configured for connection to a network such as a local ad-hoc network or the Internet. The user equipment 105 may have a passive communication interface, such as a quick response (Q) code, a radio-frequency identification (“RFID”) tag, an NFC tag, or the like, or an active communication interface, such as a modem, a transceiver, a transmitter-receiver, or the like. In an Internet of Things (“IoT”) scenario, the user equipment 105 may include sensors, metering devices such as power meters, industrial machinery, or home or personal appliances (e.g., refrigerators, televisions, personal wearables such as watches) capable of monitoring and/or reporting on its operational status or other functions associated with its operation.

Alternative embodiments of the user equipment 105 may include additional components beyond those shown in FIG. 1 that may be responsible for providing certain aspects of the functionality, including any of the functionality described herein and/or any functionality necessary to support the solution described herein. As just one example, the user equipment 105 may include input interfaces, devices and circuits, and output interfaces, devices and circuits. The input interfaces, devices, and circuits are configured to allow input of information into the user equipment 105, and are connected to a processor to process the input information. For example, input interfaces, devices, and circuits may include a microphone, a proximity or other sensor, keys/buttons, a touch display, one or more cameras, a universal serial bus (“USB”) port, or other input elements. Output interfaces, devices, and circuits are configured to allow output of information from the user equipment 105, and are connected to the processor to output information from the user equipment 105. For example, output interfaces, devices, or circuits may include a speaker, a display, vibrating circuitry, a USB port, a headphone interface, or other output elements. Using one or more input and output interfaces, devices, and circuits, the user equipment 105 may communicate with end users and/or the wireless network, and allow them to benefit from the functionality described herein.

As another example, the user equipment 105 may include a power source. The power source may include power management circuitry. The power source may receive power from a power supply, which may either be internal or external to the power source. For example, the user equipment 105 may include a power supply in the form of a battery or battery pack that is connected to, or integrated into, the power source. Other types of power sources, such as photovoltaic devices, may also be used. As a further example, the user equipment 105 may be connectable to an external power supply (such as an electricity outlet) via an input circuitry or interface such as an electrical cable, whereby the external power supply supplies power to the power source.

The radio access nodes 110 such as base stations are capable of communicating with the user equipment 105 along with any additional elements suitable to support communication between user equipment 105 or between a user equipment 105 and another communication device (such as a landline telephone). The radio access nodes 110 may be categorized based on the amount of coverage they provide (or, stated differently, their transmit power level) and may then also be referred to as femto base stations, pico base stations, micro base stations, or macro base stations. The radio access nodes 110 may also include one or more (or all) parts of a distributed radio access node such as centralized digital units and/or remote radio units (“RRUs”), sometimes referred to as remote radio heads (“RRHs”). Such remote radio units may or may not be integrated with an antenna as an antenna integrated radio. Parts of a distributed radio base stations may also be referred to as nodes in a distributed antenna system (“DAS”). As a particular non-limiting example, a base station may be a relay node or a relay donor node controlling a relay.

The radio access nodes 110 may be composed of multiple physically separate components (e.g., a NodeB component and a radio network controller (“RNC”) component, a base transceiver station (“BTS”) component and a base station controller (“BSC”) component, etc.), which may each have their own respective processor, memory, and interface components. In certain scenarios in which the radio access nodes 110 include multiple separate components (e.g., BTS and BSC components), one or more of the separate components may be shared among several network nodes. For example, a single RNC may control multiple NodeBs. In such a scenario, each unique NodeB and BSC pair, may be a separate network node. In some embodiments, the radio access nodes 110 may be configured to support multiple radio access technologies (“RATs”). In such embodiments, some components may be duplicated (e.g., separate memory for the different RATs) and some components may be reused (e.g., the same antenna may be shared by the RATs).

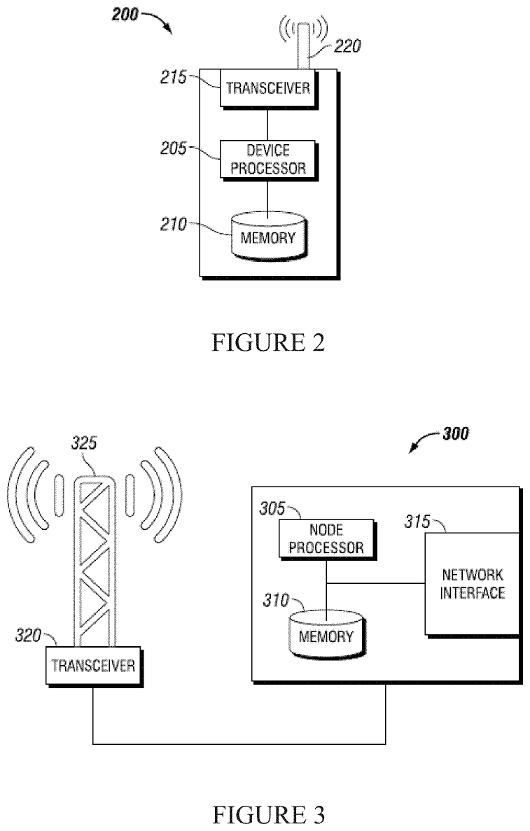

Although the illustrated user equipment 105 may represent communication devices that include any suitable combination of hardware and/or software, the user equipment 105 may, in particular embodiments, represent devices such as the example user equipment 200 illustrated in greater detail by FIG. 2. Similarly, although the illustrated radio access node 110 may represent network nodes that include any suitable combination of hardware and/or software, these nodes may, in particular embodiments, represent devices such as the example radio access node 300 illustrated in greater detail by FIG. 3. Additionally, a location server 130 may reside in the core network 120 and include any suitable combination of hardware and/or software akin to the radio access node 110.

As shown in FIG. 2, the example user equipment (also referred to as wireless device) 200 includes a processor (or processing circuitry) 205, a memory 210, a transceiver 215 and antennas 220. In particular embodiments, some or all of the functionality described above as being provided by machine type communication (“MTC”) and machine-to-machine (“M2M”) devices, and/or any other types of communication devices may be provided by the device processor 205 executing instructions stored on a computer-readable medium, such as the memory 210 shown in FIG. 2. Alternative embodiments of the user equipment 200 may include additional components (such as the interfaces, devices and circuits mentioned above) beyond those shown in FIG. 2 that may be responsible for providing certain aspects of the device's functionality, including any of the functionality described above and/or any functionality necessary to support the solution described herein.

As shown in FIG. 3, the example radio access node 300 includes a processor (or processing circuitry) 305, a memory 310, a transceiver 320, a network interface 315 and antennas 325. In particular embodiments, some or all of the functionality described herein may be provided by a base station, a radio network controller, a relay station and/or any other type of network nodes (see examples above) in connection with the node processor 305 executing instructions stored on a computer-readable medium, such as the memory 310 shown in FIG. 3. Alternative embodiments of the radio access node 300 may include additional components responsible for providing additional functionality, including any of the functionality identified above and/or any functionality necessary to support the solution described herein. Additionally, the location server 120 may include ones of the components of the radio access node 300.

The processors, which may be implemented with one or a plurality of processing devices, performs functions associated with its operation including, without limitation, precoding of antenna gain/phase parameters, encoding and decoding of individual bits forming a communication message, formatting of information and overall control of a respective communication device. Exemplary functions related to management of communication resources include, without limitation, hardware installation, traffic management, performance data analysis, configuration management, security, billing, location analysis and the like. The processors may be of any type suitable to the local application environment, and may include one or more of general-purpose computers, special purpose computers, microprocessors, digital signal processors (“DSPs”), field-programmable gate arrays (“FPGAs”), application-specific integrated circuits (“ASICs”), and processors based on a multi-core processor architecture, as non-limiting examples.

The processors may include one or more of radio frequency (“RF”) transceiver circuitry, baseband processing circuitry, and application processing circuitry. In some embodiments, the RF transceiver circuitry, baseband processing circuitry, and application processing circuitry may be on separate chipsets. In alternative embodiments, part or all of the baseband processing circuitry and application processing circuitry may be combined into one chipset, and the RF transceiver circuitry may be on a separate chipset. In still alternative embodiments, part or all of the RF transceiver circuitry and baseband processing circuitry may be on the same chipset, and the application processing circuitry may be on a separate chipset. In yet other alternative embodiments, part or all of the RF transceiver circuitry, baseband processing circuitry, and application processing circuitry may be combined in the same chipset.

The processors may be configured to perform any determining operations described herein. Determining as performed by the processors may include processing information obtained by the processor by, for example, converting the obtained information into other information, comparing the obtained information or converted information to information stored in the respective device, and/or performing one or more operations based on the obtained information or converted information, and as a result of the processing making a determination.

The memories may be one or more memories and of any type suitable to the local application environment, and may be implemented using any suitable volatile or nonvolatile data storage technology such as a semiconductor-based memory device, a magnetic memory device and system, an optical memory device and system, fixed memory and removable memory. The programs stored in the memories may include program instructions or computer program code that, when executed by an associated processor, enable the respective communication device to perform its intended tasks. Of course, the memories may form a data buffer for data transmitted to and from the same. Exemplary embodiments of the system, subsystems, and modules as described herein may be implemented, at least in part, by computer software executable by processors, or by hardware, or by combinations thereof.

The transceivers modulate information onto a carrier waveform for transmission by the respective communication device via the respective antenna(s) to another communication device. The respective transceiver demodulates information received via the antenna(s) for further processing by other communication devices. The transceiver is capable of supporting duplex operation for the respective communication device. The network interface performs similar functions as the transceiver communicating with a core network.

The antennas may be any type of antenna capable of transmitting and receiving data and/or signals wirelessly. In some embodiments, the antennas may include one or more omni-directional, sector or panel antennas operable to transmit/receive radio signals between, for example, 2 gigahertz (“GHz”) and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line.

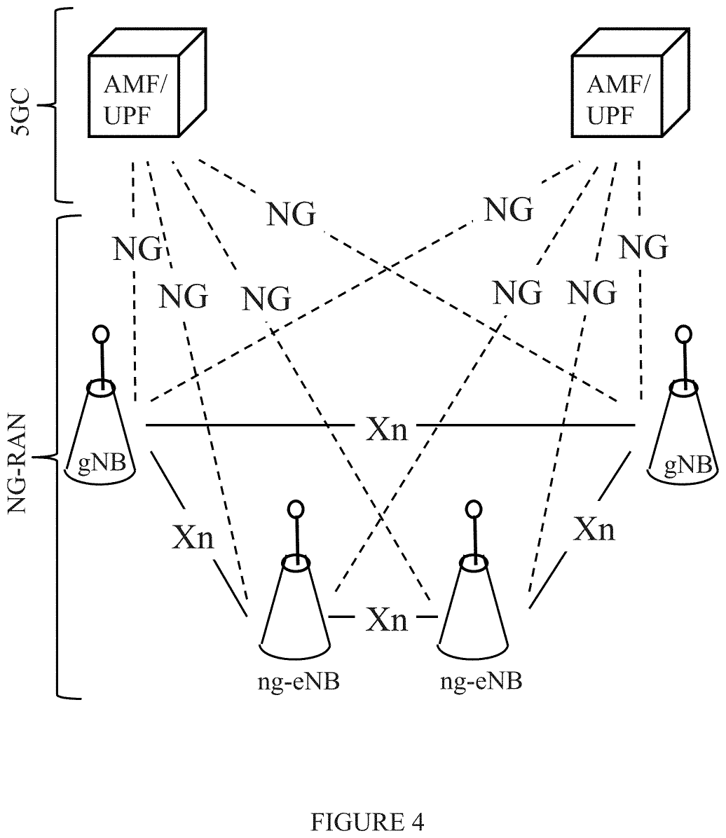

Turning now to FIG. 4, illustrated is a system level diagram of an embodiment of a communication system such as a 5G/NR communications system. The NR architecture includes terminology such as “NG” (or “ng”) denoting new radio, “eNB” denoting an LTE eNodeB, “gNB” denoting a NR base station (“BS,” one NR BS may correspond to one or more transmission/reception points), a “RAN” denoting a radio access network, “5GC” denoting a Fifth Generation (“5G”) core network, “AMF” denoting an access and mobility management function, and “UPF” denoting a user plane function. The lines between network nodes represent interfaces therebetween.

FIG. 4 illustrates an overall NR architecture with eNBs and gNBs communicating over various interfaces. In particular, the gNBs and ng-eNBs are interconnected with each other by an Xn interface. The gNBs and ng-eNBs are also connected by NG interfaces to the 5GC, more specifically to the AMF by the NG-C interface and to the UPF by the NG-U interface, as described in 3GPP Technical Specification (“TS”) 23.501, which is incorporated herein by reference. The architecture and the F1 interface for a functional split are defined in 3GPP TS 38.401, which is incorporated herein by reference.

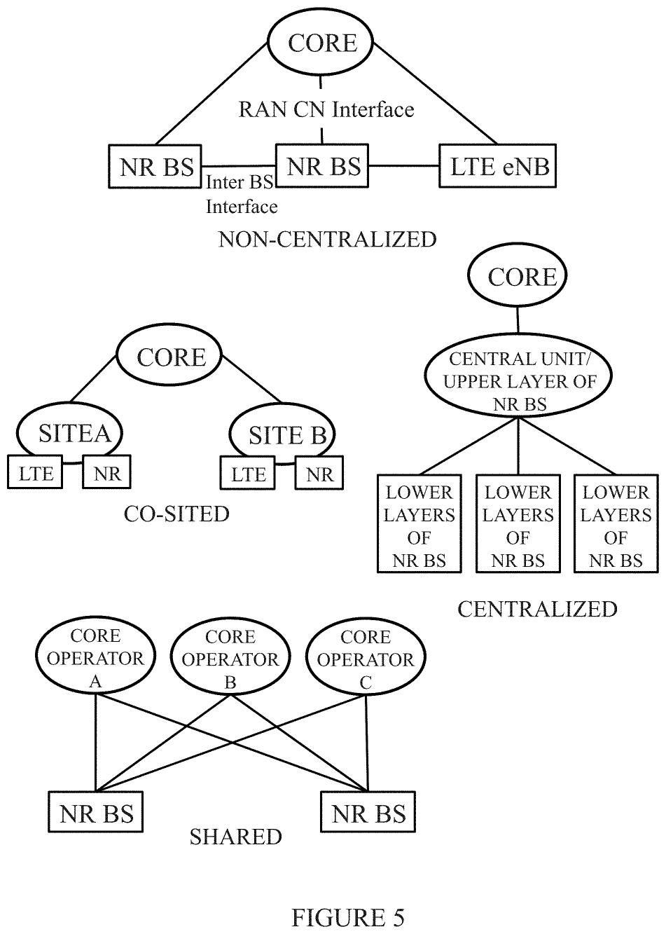

Turning now to FIG. 5, illustrated is a system level diagram of an embodiment of a communication system including 5G/NR deployment examples. The communication system illustrates non-centralized, co-sited, centralized, and shared deployments of NR base stations, LTE base stations, lower levels of NR base stations, and NR base stations connected to core networks.

Both standalone and non-standalone NR deployments may be incorporated into the communication system. The standalone deployments may be single or multi-carrier (e.g., NR carrier aggregation) or dual connectivity with a NR PCell and a NR PSCell. The non-standalone deployments describe a deployment with LTE PCell and NR. There may also be one or more LTE secondary cells (“SCells”) and one or more NR SCells.

The following deployment options are captured in NR Work Item Description (RP-170847, “New WID on New Radio Access Technology,” NTT DoCoMo, March, 2018). The work item supports a single connectivity option including NR connected to 5G-CN (“CN” representing a core network, option 2 in TR 38.801 section 7.1). The work item also supports dual connectivity options including E-UTRA-NR DC (“E-UTRA” represents evolved universal mobile telecommunications system (“UMTS”) terrestrial radio access, and “DC” represents dual connectivity) via an evolved packet core (“EPC”) where the E-UTRA is the master (Option 3/3a/3x in TR 38.801 section 10.1.2), E-UTRA-NR DC via 5G-CN where the E-UTRA is the master (Option 7/7a/7x in TR 38.801 section 10.1.4), and NR-E-UTRA DC via 5G-CN where the NR is the master (Option 4/4A in TR 38.801 section 10.1.3). Dual connectivity is between E-UTRA and NR, for which the priority is where E-UTRA is the master and the second priority is where NR is the master, and dual connectivity is within NR. The aforementioned standards are incorporated herein by reference.

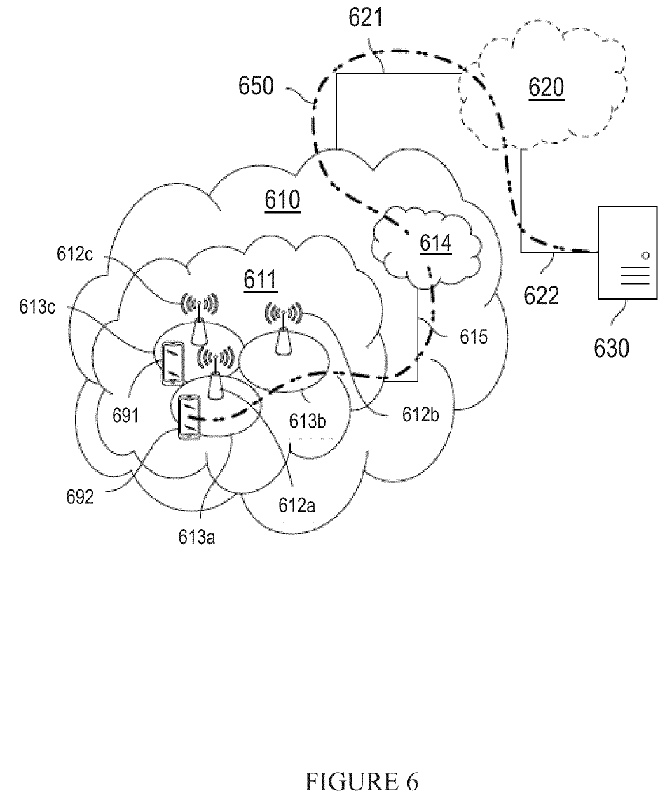

Turning now to FIG. 6, illustrated is a system level diagram of an embodiment of a communication system including a communication network (e.g., a 3GPP-type cellular network) 610 connected to a host computer 630. The communication network 610 includes an access network 611, such as a radio access network, and a core network 614. The access network 611 includes a plurality of base stations 612a, 612b, 612c (also collectively referred to as 612), such as NBs, eNBs, gNBs or other types of wireless access points, each defining a corresponding coverage area 613a, 613b, 613c (also collectively referred to as 613). Each base station 612a, 612b, 612c is connectable to the core network 614 over a wired or wireless connection 615. A first user equipment (“UE”) 691 located in coverage area 613c is configured to wirelessly connect to, or be paged by, the corresponding base station 612c. A second user equipment 692 in coverage area 613a is wirelessly connectable to the corresponding base station 612a. While a plurality of user equipment 691, 692 are illustrated in this example, the disclosed embodiments are equally applicable to a situation where a sole user equipment is in the coverage area or where a sole user equipment is connecting to the corresponding base station 612.

The communication network 610 is itself connected to the host computer 630, which may be embodied in the hardware and/or software of a standalone server, a cloud-implemented server, a distributed server or as processing resources in a server farm. The host computer 630 may be under the ownership or control of a service provider, or may be operated by the service provider or on behalf of the service provider. The connections 621, 622 between the communication network 610 and the host computer 630 may extend directly from the core network 614 to the host computer 630 or may go via an optional intermediate network 620. The intermediate network 620 may be one of, or a combination of more than one of, a public, private or hosted network; the intermediate network 620, if any, may be a backbone network or the Internet; in particular, the intermediate network 620 may include two or more sub-networks (not shown).

The communication system of FIG. 6 as a whole enables connectivity between one of the connected user equipment 691, 692 and the host computer 630. The connectivity may be described as an over-the-top (“OTT”) connection 650. The host computer 630 and the connected user equipment 691, 692 are configured to communicate data and/or signaling via the OTT connection 650, using the access network 611, the core network 614, any intermediate network 620 and possible further infrastructure (not shown) as intermediaries. The OTT connection 650 may be transparent in the sense that the participating communication devices through which the OTT connection 650 passes are unaware of routing of uplink and downlink communications. For example, a base station 612 may not or need not be informed about the past routing of an incoming downlink communication with data originating from a host computer 630 to be forwarded (e.g., handed over) to a connected user equipment 691. Similarly, the base station 612 need not be aware of the future routing of an outgoing uplink communication originating from the user equipment 691 towards the host computer 630. A location server as described herein may be resident in the host computer 630 or elsewhere such as within the core network 614 or even distributed down to a base station or user equipment.

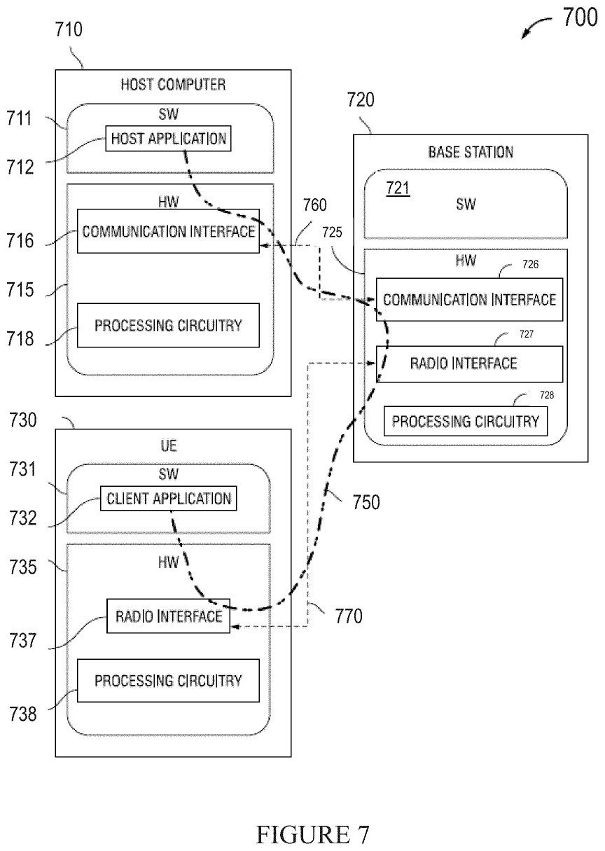

Turning now to FIG. 7, illustrated is a block diagram of an embodiment of a communication system 700. In the communication system 700, a host computer 710 includes hardware 715 including a communication interface 716 configured to set up and maintain a wired or wireless connection with an interface of a different communication device of the communication system 700. The host computer 710 further includes processing circuitry (a processor) 718, which may have storage and/or processing capabilities. In particular, the processing circuitry 718 may include one or more programmable processors, application-specific integrated circuits, field programmable gate arrays or combinations of these (not shown) adapted to execute instructions. The host computer 710 further includes software 711, which is stored in or accessible by the host computer 710 and executable by the processing circuitry 718. The software 711 includes a host application 712. The host application 712 may be operable to provide a service to a remote user, such as a user equipment (“UE”) 730 connecting via an OTT connection 750 terminating at the user equipment 730 and the host computer 710. In providing the service to the remote user, the host application 712 may provide user data which is transmitted using the OTT connection 750.

The communication system 700 further includes a base station 720 provided in the communication system 700 including hardware 725 enabling it to communicate with the host computer 710 and with the user equipment 730. The hardware 725 may include a communication interface 726 for setting up and maintaining a wired or wireless connection with an interface of a different communication device of the communication system 700, as well as a radio interface 727 for setting up and maintaining at least a wireless connection 770 with a user equipment 730 located in a coverage area (not shown in FIG. 7) served by the base station 720. The communication interface 726 may be configured to facilitate a connection 760 to the host computer 710. The connection 760 may be direct or it may pass through a core network (not shown in FIG. 7) of the communication system 700 and/or through one or more intermediate networks outside the communication system 700. In the embodiment shown, the hardware 725 of the base station 720 further includes processing circuitry (a processor) 728, which may include one or more programmable processors, application-specific integrated circuits, field programmable gate arrays or combinations of these (not shown) adapted to execute instructions. The base station 720 further has software 721 stored internally or accessible via an external connection.

The user equipment 730 includes hardware 735 having a radio interface 737 configured to set up and maintain a wireless connection 770 with a base station 720 serving a coverage area in which the user equipment 730 is currently located. The hardware 735 of the user equipment 730 further includes processing circuitry (a processor) 738, which may comprise one or more programmable processors, application-specific integrated circuits, field programmable gate arrays or combinations of these (not shown) adapted to execute instructions. The user equipment 730 further includes software 731, which is stored in or accessible by the user equipment 730 and executable by the processing circuitry 738. The software 731 includes a client application 732. The client application 732 may be operable to provide a service to a human or non-human user via the user equipment 730, with the support of the host computer 710. In the host computer 710, an executing host application 712 may communicate with the executing client application 732 via the OTT connection 750 terminating at the user equipment 730 and the host computer 710. In providing the service to the user, the client application 732 may receive request data from the host application 712 and provide user data in response to the request data. The OTT connection 750 may transfer both the request data and the user data. The client application 732 may interact with the user to generate the user data that it provides.

It is noted that the host computer 710, base station 720 and user equipment 730 illustrated in FIG. 7 may be identical to the host computer 630, one of the base stations 612a, 612b, 612c and one of the user equipment 691, 692 of FIG. 6, respectively. This is to say, the inner workings of these entities may be as shown in FIG. 7 and independently, the surrounding network topology may be that of FIG. 6.

In FIG. 7, the OTT connection 750 has been drawn abstractly to illustrate the communication between the host computer 710 and the use equipment 730 via the base station 720, without explicit reference to any intermediary devices and the precise routing of messages via these devices. Network infrastructure may determine the routing, which it may be configured to hide from the user equipment 730 or from the service provider operating the host computer 710, or both. While the OTT connection 750 is active, the network infrastructure may further take decisions by which it dynamically changes the routing (e.g., on the basis of load balancing consideration or reconfiguration of the network).

A measurement procedure may be provided for the purpose of monitoring data rate, latency and other factors on which the one or more embodiments improve. There may further be an optional network functionality for reconfiguring the OTT connection 750 between the host computer 710 and user equipment 730, in response to variations in the measurement results. The measurement procedure and/or the network functionality for reconfiguring the OTT connection 750 may be implemented in the software 711 of the host computer 710 or in the software 731 of the user equipment 730, or both. In embodiments, sensors (not shown) may be deployed in or in association with communication devices through which the OTT connection 750 passes; the sensors may participate in the measurement procedure by supplying values of the monitored quantities exemplified above, or supplying values of other physical quantities from which software 711, 731 may compute or estimate the monitored quantities. The reconfiguring of the OTT connection 750 may include message format, retransmission settings, preferred routing, etc.; the reconfiguring need not affect the base station 720, and it may be unknown or imperceptible to the base station 720. Such procedures and functionalities may be known and practiced in the art. In certain embodiments, measurements may involve proprietary user equipment signaling facilitating the host computer's 710 measurements of throughput, propagation times, latency and the like. The measurements may be implemented in that the software 711, 731 causes messages to be transmitted, in particular empty or ‘dummy’ messages, using the OTT connection 750 while it monitors propagation times, errors, etc. Additionally, the communication system 700 may employ the principles as described herein. Additionally, location services may be provided in accordance with a location server embodied in the host computer 710 and base station 720 and user equipment 730.

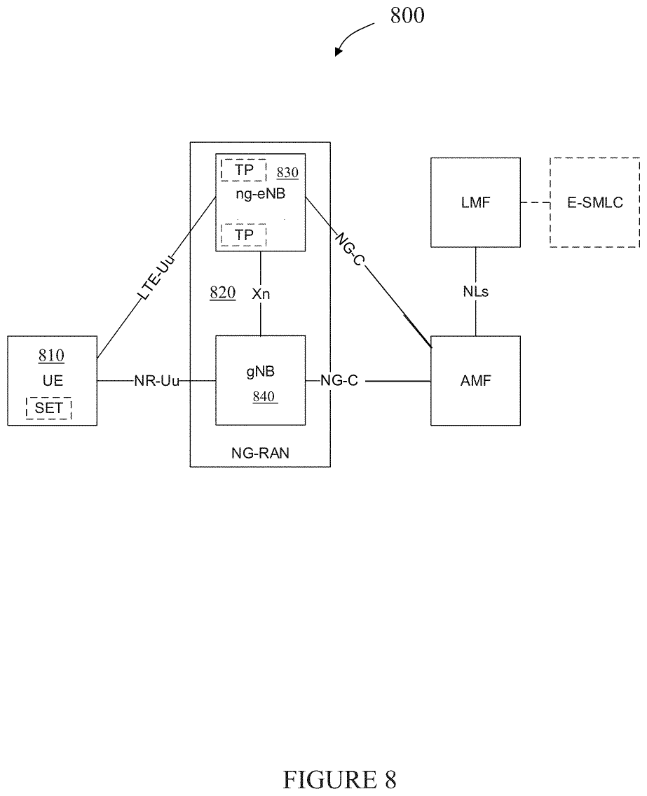

Turning now to FIG. 8, illustrated is a block diagram of an embodiment of a communication system 800. The communication system 800 includes a user equipment 810 communicating with a NG-Radio Access Network (“RAN”) 820 including ng-eNB 830 and a gNB 840. It should be understood that the ng-eNB 830 and a gNB 840 may not always be present. When both the ng-eNB 830 and a gNB 840 are present, the NG-C interface may only present for one of them. The ng-eNB 830 provides E-UTRA user plane and control plane protocol terminations towards the user equipment 810 and the gNB 840 provides NR user plane and control plane protocol terminations towards the user equipment 810.

The NG-RAN 820 communicates with an access and mobility management (“AMF”) 850. The AMF 850 performs various functions including, without limitation, registration management, connection management, reachability management, mobility management, access authentication and access authorization, and security functionality. The AMF 850 communicates with a location management function (“LMF”) 860, which is a location server that determines, using information from the user equipment 810 and/or NG RAN 820 a location of the user equipment 810. The LMF 860 communicates with an evolved-serving mobile location center (“E-SMLC”) 870 employable to calculate positional information and coordinate location-based services. There are also interactions between the LMF 860 and a gNodeB via a New Radio positioning protocol A (“NRPPa”). The interactions between the gNodeB and the device is supported via the radio resource control (“RRC”) protocol.

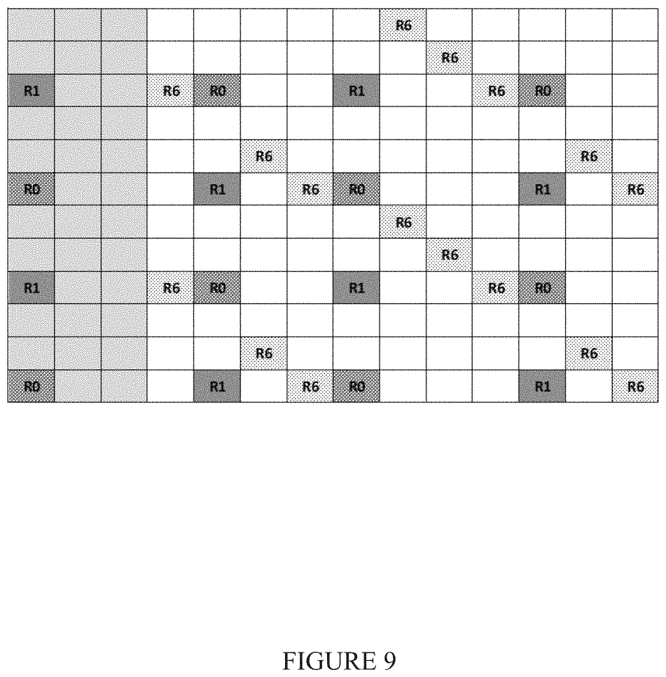

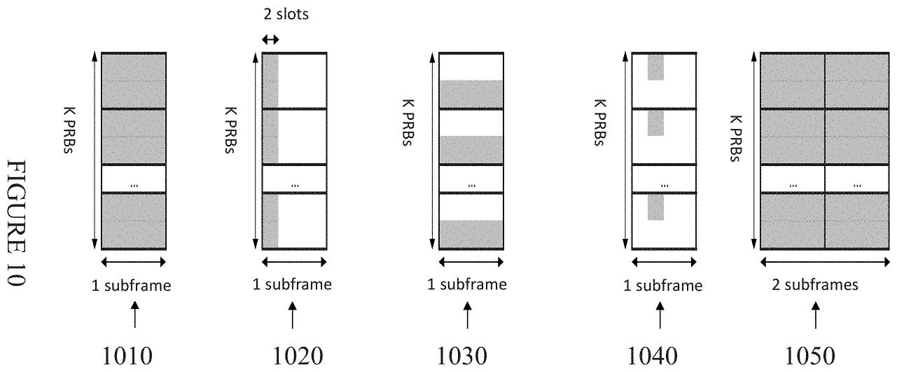

Turning now to FIG. 9, illustrated is a block diagram of an embodiment of a positioning reference signal (“PRS”) pattern. As mentioned above, in the legacy LTE standards, the control region or PDCCH/PCFICH/PHICH is designed to be limited to a very specific part of the subframe (typically 1-3 symbols in the beginning of any DL subframe). The PRS pattern is then designed to fit into the data region of the subframe, as shown in FIG. 9. Moreover, the cell-specific reference signal (“CRS”) is also prioritized so that PRS is never transmitted in PRS symbols. In FIG. 9, the PRS is not transmitted in symbols 0, 1 and 2 where PDCCH is transmitted and also in symbols 4, 7 and 11 in which CRS is transmitted. In the case of 4 ports used for transmitting CRS, the PRS is additionally not transmitted in symbol 8. Thus, FIG. 9 shows the mapping of positioning reference signals (with normal cyclic prefix). Greyed out is the control channel area. R0 and R1 are the CRS resource elements (“REs”) for two antenna ports. The PRS are transmitted from antenna port 6 (see R6).

In NR, the envisioned positioning solution is expected to be based on one or a combination of existing NR reference signals, extensions of the existing NR signals, and new PRS. The considered existing NR reference signals are the tracking reference signal (“TRS”, also referred to as CSI RS for tracking) as well as the synchronization signal block (“SSB”). Multiple patterns have been discussed to extend the TRS as well as design a new PRS is under discussion (see, e.g., Ericsson contribution R1-1901195 DL Positioning Solutions from RAN1 #1901AH and U.S. Patent Application Ser. No. 62/791,630, which are incorporated herein by reference).

The physical downlink control channel (“PDCCH”) is responsible for sending downlink control information (“DCI”) to the user equipment (“UE”) from the gNodeB. Such information includes HARQ feedback, uplink grants, downlink scheduling of the PDSCH, and more. A physical downlink control channel consists of 1, 2, 4, 8, or 16 control-channel elements (“CCEs”). A control-resource set (“CORESET”) consists of N_“RB”\hat{ }“CORESET” resource blocks in the frequency domain and N_“symb”\hat{ }“CORESET” ∈{1,2,3} symbols in the time domain. A control-channel element consists of 6 resource-element groups (“REGs”) where a resource-element group equals one resource block during one orthogonal frequency domain multiplexing (“OFDM”) symbol. The resource element groups within a control resource set are numbered in increasing order in a time-first manner, starting with 0 for the first OFDM symbol and the lowest-numbered resource block in the control resource set. A UE can be configured with multiple control-resource sets. Each control resource set is associated with one CCE-to-REG mapping. Many of the parameters controlling CORESET are configured via higher-layer protocol (radio resource control). There can be multiple CORESETS present in a subframe, as controlled by RRC signaling. There can be different types of CORESETs depending on its contents, e.g., RMSI CORESET (used for the scheduling of remaining minimum system information (“RMSI”), etc.).

In the time domain, an synchronization signal/physical broadcast channel (“SS/PBCH”) block (or SSB) consists of 4 OFDM symbols, numbered in increasing order from 0 to 3 within the SS/PBCH block, where primary synchronization signal (“PSS”), secondary synchronization signal (“SSS”), and PBCH with associated demodulation reference signal (“DM-RS”) are mapped to pre-defined symbols and subcarriers.

In the frequency domain, an SS/PBCH block consists of 240 contiguous subcarriers (20 physical resource blocks (“PRBs”)) with the subcarriers numbered in increasing order from 0 to 239 within the SS/PBCH block. The number of SSBs within a half frame can be up to 64, depending on the numerology and frequency ranges (e.g., up to 64 SSBs for 120 kilohertz (“kHz”) or 240 kHz in frequency range 2 (“FR2”), while up to 4 SSBs for frequencies below 3 GHz and up to 8 SSBs for frequencies below 6 gigahertz (“GHz”)). The SSB transmissions repeat with a periodicity of 5, 10, 20, 40, 80, or 160 milliseconds (“ms”). The different SSBs within the half subframe may be transmitted via different beams. Some of the SSBs may be not transmitted, which is indicated to the UE by a pattern via higher-layer signaling.

In LTE, subcarrier spacing (“SCS”) of 15 kHz has only been assumed during the sounding reference signal (“SRS”) switching studies, and the minimum transmission time interval (“TTI”) in LTE is one subframe (1 ms long) which takes up two slots. A radio frame contains therefore 10 subframes or 20 slots.

In NR, the SCS is flexible and needs to be taken into account. Multiple OFDM numerologies are supported as given by TABLE 1 below where p and the cyclic prefix for a bandwidth part are obtained from the higher-layer parameter suhcarrierSpacing and cyclicPrefrx, respectively. The supported numerology is also dependent on the frequency range, e.g., SCS of 15 kHz, 30 kHz and 60 kHz are used in frequency range 1 (“FR1”, which is from 450 megahertz (“MHz”) and up to 6 GHz), while SCS of 60 kHz, 120 kHz and 240 kHz are used in FR2 (which is from 24 GHz and up to 52.6 GHz). Sixty (60) kHz may be used for control and data transmissions, but not for SSB transmissions in FR2, while 240 kHz may be used for SSB transmissions, but not for control or data transmissions. Sixty (60) kHz is also optional for the UE in FR1.

The numerology in NR has impact also on the radio frame structure, i.e., depending on the numerology the number of slots per radio frame is different. The minimum TTI in NR is one slot.

TABLE 1
Supported transmission numerologies in NR Rel-15

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

TABLE 2
Number of OFDM symbols per slot, slots per frame,
and slots per subframe for normal cyclic prefix

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

As mentioned above, there is currently no agreement or designs proposed to handle collisions with the NR positioning reference signals. The 3GPP status is that PRS should not conflict with other signals and should have priority. The possibility of sharing the PRS subframe is under consideration as shown in Table 3 below with respect to RAN1 #1901 agreements, which are incorporated herein by reference.

TABLE 3
RAN1#1901 agreements

```
NR DL PRS design for FR1 and FR2 supports:
  Configurable NR DL PRS signal bandwidth
    FFS granularity of configuration, relationship with BWPs, whether the
    configuration is cell and/or UE specific
  Configurable NR DL PRS signal numerology (SCS)
    FFS configurability of CP for NR DL PRS
  Configurable NR DL PRS frequency and time allocation
  Use of DL beam sweeping/alignment
    i.e. beam alignment of gNB DL PRS transmission and UE reception of DL PRS
  Localized in time NR DL PRS transmissions with periodic and/or on-demand resource
  allocation
    FFS signaling details
  Dedicated NR DL PRS resources - time-frequency grid at resource block level
    PRS transmitted in one cell may or may not collide with PRS transmissions in
    other cell
      e.g. frequency vShift/comb-offset is the same or different for two
      different PRSs in the same RB
    There is no data/control transmission in time-frequency grid of dedicated NR-
    DL PRS resources
    FDM multiplexing with other signals at RE level inside of PRS time-frequency
    grid is precluded
    FFS interference randomization techniques across PRS signals
  FFS shared in time/frequency NR DL PRS resources with other transmissions including
  data/control
    FFS which physical channel/signals can share resources with NR DL PRS
    FFS interference randomization techniques for PRS transmission with other
    signals
```

It is preferable that PRS resource be allowed to prioritize control channel transmissions and SSB occasions. Without this, communication based on HARQ feedback may suffer and coverage of UEs monitoring SSB will have to be compromised. This disclosure proposes a system and method to manage collision to mitigate the loss of HARQ opportunities and SSB search occasions.

In an embodiment, the problem of collision avoidance between PRS and control channels or SSBs can be solved by reserving certain parts of the PRS subframe time-frequency grid to the use of SSB and/or control channel resources. Unlike in LTE, in NR control channel design is flexible and the control channels can be almost anywhere within a subframe, hence just using a single statically design PRS pattern over a fixed PRB region is not the answer for NR.

Certain systems and methods as set forth herein maintain the possibility of control channel reception (enabling, e.g., HARQ feedback) and SSB (enabling cell search/update) during a positioning subframe. The flexible PRS design enables flexibility of the control channel design in NR.

The term CORESET includes a dynamically configured set of control channel resource elements (“REs”), e.g., as CORESETs specified in TS 38.211 v.15.4.0, which is incorporated herein by reference. The term SSB may include SS/PBCH block as described in TS 38.211 v.15.4.0 or more generally a block of REs having at least synchronization signal and a broadcast channel such as PBCH. The term PRS herein is a generic term which may include positioning reference signals in NR, signals to be used at least for UE positioning, TRS, SSB, SRS, etc. The PRS may be transmitted in the downlink (“DL”) or uplink (“UL”).

According to an embodiment, a UE or a network node (e.g., a radio network node or base station, core network node, positioning node, etc.) configures or determines (e.g., based on received signaling) at least one of a PRS region, which includes the PRS intended for positioning, and a PRS-free region that is non-overlapping in time and/or frequency with the PRS region and includes the REs where PRS cannot be allocated. If one of the PRS region or PRS-free region is configured or determined (e.g., based on signaling), then the other parameter can also be determined (e.g., when any REs beyond the PRS region include PRS-free region).

A PRS region is a set or a group of REs that may be within a single slot or subframe or may include one or more symbols, slots, subframes, radio frames, or any combination thereof. In one example, the PRS region includes one subframe or one slot over a certain bandwidth. In another example, the PRS region includes a group of REs over 20 PRBs and N symbols (N=1, 2, 3, 4, 5, . . . ) starting from symbol M (M=0, 1, 2, . . . ). The REs within one PRS region may or may not be consecutive in time and/or frequency. A PRS region can be UE specific, cell-specific, cell-group specific (e.g., associated with a group or list of cells), or frequency specific. The PRS region can also be associated with a certain PRS resource or resource set.

The PRS region may contain one or more of: signals (DL and/or UL), channels (DL and/or UL), and SSBs, which are intended for positioning and may be configured within the PRS region. A PRS region may include only DL signals/channels/SSBs, only UL signals/channels/, or even both DL and UL signals/channel/SSBs for positioning. Some or all signals/channel/SSBs within a PRS region may also be used for other purposes in addition to the positioning. In another example, a PRS region may include one or more but not all SSBs (those which are intended for positioning) within a half frame.

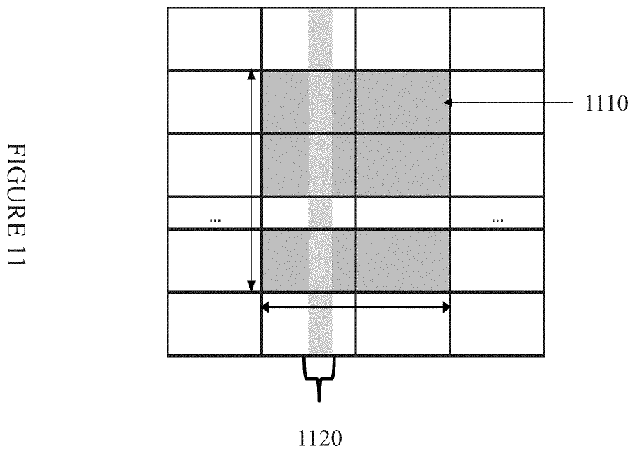

Turning now to FIG. 10, illustrated is block diagram of embodiments of PRS regions (cross-hatched in the FIGURE). The first PRS region 1010 includes a subframe times “K” PRBs (full subframe). The second PRS region 1020 includes 2 slots (120 kHz) times “K” PRBs (part of a subframe). The third PRS region 1030 includes a lower half subframe times “K” PRBs (non-contiguous in frequency, part of a subframe). The fourth PRS region 1040 includes 2 slots (120 kHz) times “R” subcarriers times “K” PRBs (non-contiguous in frequency, part of a subframe). The fifth PRS region 1050 includes 2 subframes times “K” PRBs (full subframe).

The PRS region configuration may include E-UTRA absolute radio frequency channel number (“EARFCN”) or frequency, a starting point or an offset (e.g., in symbols, slots, subframes, radio frames, or any combination thereof, etc.) of the PRS region with respect to a reference point in time (e.g., 0 if PRS region starts from the beginning of a slot or a subframe), wherein the reference point can be a slot border (e.g., beginning or end of), subframe border, radio frame border, a pre-defined symbol within radio frame, subframe, or slot. The PRS region configuration may include a starting point or an offset (e.g., PRBs, subcarriers, or a combination, etc.) of the PRS region with respect to a reference point in frequency (e.g., center frequency, subcarrier with a specific index, PRB with a specific index, etc.), and a last point in time or size in time or duration (e.g., in symbols, slots, subframes, radio frames, or a combination). The PRS region configuration may include a last point in frequency or size in frequency or bandwidth (e.g., in PRBs, subcarriers, or combination), a numerology (e.g., cyclic prefix (“CP”) and/or SCS) used for any signal or channel within the PRS region, and one or more configuration parameters or patterns for DL signals and/or channels and/or SSBs intended for positioning and to be transmitted within the PRS region. The PRS region configuration may include one or more configuration parameters or patterns for UL signals and/or channels intended for positioning and to be transmitted within the PRS region, one or more configuration parameters related to transmit power levels of one or more signals or channels within the PRS region, and periodicity of PRS region if it repeats with a certain periodicity. Of course, the PRS region may be configured in other arrangements as well.

The PRS region or PRS-free region configuration may be signaled via dedicated, multicast, or broadcast signaling from a radio network node to one or more UEs. Alternatively, the PRS region or PRS-free region configuration may be signaled via higher-layer signaling (e.g., RRC, system information (“SI”)) or physical layer signaling (e.g., control channel, broadcast channel) or their combination from a radio network node to one or more UEs. The PRS region or PRS-free region configuration may be signaled from a radio network node to location/positioning server, from a radio network node to another radio network node (e.g., via Xn or X2), from a radio network node to a network management or controlling node (e.g., operations and maintenance (“O&M”), self-organizing network (“SON”), etc.) or from a network management or controlling node to a radio network node (the received configuration may be then configured for the radio network node transmissions). The PRS region or PRS-free region configuration may be signaled via higher-layer signaling from location/positioning server to the UE (e.g., via positioning protocol similar to LTE positioning protocol (“LPP”)). The UE may receive the PRS region or PRS-free region configuration of one (e.g., from which the configuration is received) or a plurality of cells, where each of the plurality of cells is on different carrier frequencies or at least some are on the same carrier frequency. Of course, the PRS region or PRS-free region configuration may employ other signaling procedures as well.

The PRS region and/or PRS-free region information may be useful for UE to adapt its receiver between receiving PRS and non-PRS signals/channels, e.g., because weaker signals may need to be received for positioning or a different antenna configuration may be needed for PRS signals compared to non-PRS signals. The PRS region of one radio network node may also be used by another radio network node, e.g., to determine PRS-free region or for configuring own PRS within the same PRS region.

The PRS-free region may be used, e.g., for one or more CORESETs since PRS will be limited to the PRS region. The PRS-free region may also include one or more SSBs not intended for UE positioning (at least for one UE). A PRS-free region may be determined implicitly (e.g., any REs beyond the PRS region) or explicitly (e.g., to configure the PRS-free region to a specific or smaller set of REs where the UE knows that a PRS is not located).

The PRS/PRS free region may also be useful to the location server to determine the need of positioning resources to be spent on a given positioning measurement. For example, with the network nodes informing the location server of comparatively large PRS free region, the location server may decide to configure the UE with longer (in time) or wider (in frequency) measurement period compared to a network configuration with a shorter and narrower PRS free region.

According to another embodiment, a “CORESET gap” of a configurable size (e.g., number of symbols, configuration parameters similar to PRS/PRS-free region) is created within a positioning occasion. The CORESET gap configuration may also be signaled to another node to indicate a part of the PRS subframe or positioning occasion to be reserved for CORESET allocation. The PRS subframe or positioning occasion may include any PRS as set forth above, e.g., DL and/or UL signals or channels for positioning.

The signaling directions between different nodes (including UEs) can be similar to the above signaling for PRS region/PRS-free region. In a first example, the gap means a gap in PRS transmission, i.e., that the PRS are not transmitted by the corresponding cell transmitting CORESET in these resources.

In a second example, the PRS may be transmitted by a cell different from the cell transmitting the CORESET. In this case, from the UE perspective, the gap means that the UE would need to create a gap in receiving the PRS during a PRS occasion in order to receive one or more CORESETs. This UE gap (in UE reception during the PRS occasion) may be needed, for instance, because the UE may the PRS from different directions at the same time due to receive beamforming, e.g., while receiving the PRS according to a PRS configuration or PRS region configuration (if combined with the first embodiment). The UE can create a small gap in subframes with PRS (or PRS occasions) to receive the CORESET from the serving cell, even on the same frequency, while not receiving PRS from other directions. During these gaps, the UE would tune its receiver to receive one or more CORESETs, and then tune back for receiving the PRS in the positioning occasion. A specific example herein is when the CORESET and the PRS occasion overlap in frequency or CORESET is within the PRS bandwidth.

If the neighbor cell transmitting the PRS is aware of the CORESET area (e.g., by means of PRS-free region), then to augment (e.g. optimize) resources it may choose to not transmit the PRS during the time the UE will need to receive CORESET. Otherwise, it can transmit (and these signals may be received by other UEs), but this UE would still be expected to tune to the serving cell and receive the CORESET.

Turning now to FIG. 11, illustrated is a block diagram of an embodiment of a CORESET gap configuration. The lighter diagonal cross-hatched regions (one of which is designated 1110) represent subframes with at least a neighbor cell PRS (may or may not contain other signals/channels not related to positioning). The darker cross-hatched region (generally designated 1120) represent CORESET gaps. The idea with the CORESET gap is that it can be extended to a more general gap during the positioning occasion (gap in PRS transmission, as in the first example; or gap in PRS reception, as in the second example) for other critical signals/channels, including SSBs not intended for positioning.

In a further embodiment, the gap can be constrained to a sub-bandwidth of the available bandwidth in a bandwidth part (“BWP”), or configured to occupy the full bandwidth. In other words, the gap bandwidth may also be configurable in one example or pre-defined in another example wherein full bandwidth is a special case.

Since the SSB can be considered as a secondary positioning reference signal, and has a key role in maintaining coverage, the SSB resource allocation should be maintained. Therefore, in one embodiment when an SSB resource element collides with a PRS, the PRS is dropped or punctured and the SSB is transmitted instead.

In another embodiment, the SSB location (resources) is made known to the UE (e.g., a cell provides SSB configuration to the location server and the location server informs the UE or the serving cell provides SSB configuration of other cells for positioning purpose). In the case the SSB collides with the PRS not within the SSB configuration and search window (SS/PBCH block measurement time configuration (“SMTC”) window) known to the UE (e.g. for mobility purpose), the UE is made aware of the SSB location (colliding with PRS) via the assistance data provided by the location server. The UE then is not expected to receive the PRS in all SSB locations it is aware of and will instead search for SSB.

If the PRS is on frequencies not used for mobility measurements, the UE may not even receive the SMTC window, hence all SSBs locations would be provided to the UE on that frequency. Also, the location server may not be aware of whether the UE is using a certain frequency for mobility measurements and has received the SMTC configuration, in which case the location server may assume that the UE does not know any SSB location on this frequency and can provide all SSB locations (on that frequency) to the UE or at least all SSB locations (on that frequency) colliding with the PRS occasions.

In another embodiment, the SSB location is delivered by assistance data containing, e.g., one or more parameters related to SSB configuration such as SSB periodicity and an offset with respect to a reference (e.g., number of subframes with respect to system frame number 0 (“SFN0”) of a reference cell and/or the SSB slot offset and/or symbols used for SSB and/or indication of whether a specific SSB is actually transmitted or not at the location). The assistance data is provided by a NR Positioning Protocol (NPP). Alternatively, system information broadcast can provide the information.

In another embodiment, the UE can use both the SSB as well as the PRS to report the positioning measurement. The UE can also measure on SSB if it is in a positioning occasion. In another embodiment, the measurement is performed jointly on the PRS and the SSB or the measurements are combined into one. Of course, the measurements may be performed separately.

In another embodiment, the UE may report a single measurement for which it may use both SSB and PRS or it may report both measurements (separately for SSB or PRS) or it may report a function of two measurements (e.g., the best measurement, the most accurate, the average, weighted average (e.g., with the weights related to the measurement uncertainty), the minimum, the maximum, etc.). The UE may also indicate implicitly or explicitly in a measurement report whether the SSB is used for the measurements or which signals were used for the positioning measurements, etc. The location server may also explicitly configure the UE to use/not use the SSB for positioning measurements in addition to PRS.

In another embodiment, the UE can indicate to the location server whether and/or what SSB information is needed for the UE. The UE may also implicitly or explicitly indicate carrier frequencies where it knows some or all or does not know any SSB location. Based on this information, the location server will provide the requested information in the assistance data.

In another embodiment, based on the level of UE awareness of the SSB locations on carrier frequency, the UE can choose to use only SSB information from location, only SSB information (including SMTC configuration) from serving cell, or it may combine or complement (use both) SSB information from location server and serving cell.

Herein, the term “collide” in “SSB allocation can collide with PRS occasions”, wherein the SSB and PRS occasion may be transmitted from or mapped to REs in different cells (in one example) or in the same cell (in another example), may include overlapping in time at least in part, overlapping in time and frequency at least in part, not overlapping in time but separated in time by less than a threshold, overlapping in time and not overlapping in frequency but having different numerologies (e.g., when SCSs are different, the UE cannot receive both and needs to choose based on the embodiments above), and overlapping in time and frequency and having different numerologies.

In an embodiment, an apparatus (such as a network node or user equipment (UE)) in a communication system (e.g., a 5G communication system) includes processing circuitry configured to determine at least one of a positioning reference signal (PRS) region and a PRS-free region that is non-overlapping in time and/or frequency with said PRS region, the PRS-free region comprising resource elements in which a PRS cannot be allocated.

The PRS region may include a group of resource elements within a single slot or subframe, or may include one or more symbols, slots, subframes, radio frames, or any combination thereof. The PRS region may include one subframe or one slot over a certain bandwidth. The PRS region may include a group of resource elements over a number (e.g., 20) of physical resource blocks and a number of symbols. The PRS region may be at least one of UE specific, cell specific, cell-group specific, and frequency specific. The PRS region may include at least one of a downlink signal, an uplink signal, a downlink channel, an uplink channel, and a synchronization signal/physical broadcast channel (SSB).

The PRS region or the PRS-free region is signaled via at least one of dedicated, multicast, and broadcast signaling from a network node to a user equipment. The PRS region or the PRS-free region is signaled by at least one of higher-layer signaling or physical-layer signaling from a network node to a user equipment; from a network node to a location server; higher-layer signaling from the location server to the user equipment, from the network node to another network node; from the network node to a network management or controlling node; and from the network management or controlling node to a network node.

In another embodiment, an apparatus (such as a network node or user equipment (UE)) in a communication system includes processing circuitry configured to signal a control-resource set (CORESET) gap to indicate a part of a positioning reference signal (PRS) subframe or positioning occasion to be reserved for a CORESET allocation. The CORESET gap is of a configurable size, and may include a gap in a PRS transmission. The CORESET gap is constrained to a sub-bandwidth of available bandwidth in a bandwidth part.

time a user equipment (UE) will need to receive the CORESET from the neighboring cell.

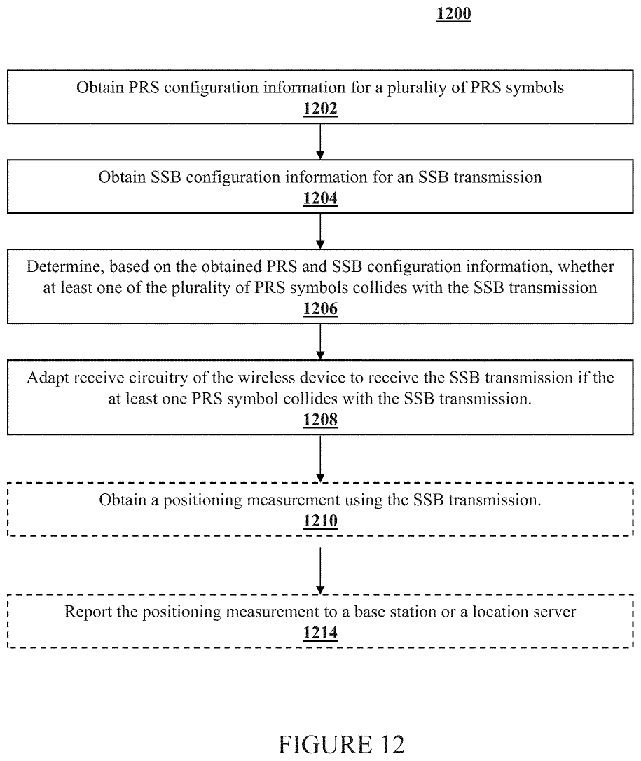

FIG. 12 is a flowchart illustrating an example method 1200 of operating a wireless device (e.g., wireless device 105, 200) in a wireless communication network 100. The method 1200 comprises a step 1202 in which the wireless device obtains PRS configuration information for a plurality of PRS symbols. In one embodiment, the PRS configuration information defines a region in which the plurality of PRS symbols are to be transmitted by a base station (e.g., as explained above with reference to FIG. 10). Alternatively (or in addition), the PRS configuration information defines a region in which the plurality of PRS symbols are not to be transmitted by the base station.

In step 1204, the wireless device obtains SSB configuration information for an SSB transmission. In one embodiment, at least one of the plurality of PRS symbols corresponds to the same cell or base station as the SSB transmission. For example, they may be transmitted by the same cell or base station. Alternatively, the SSB transmission and at least one of the plurality of PRS symbols correspond to different cells. In one embodiment, the wireless device may obtain the PRS configuration information and/or the SSB configuration information from, e.g., a location server or a base station, in the wireless communication network. In one embodiment, the SSB configuration information includes one or more of a periodicity parameter and an offset parameter. In one embodiment, the wireless device indicates whether and/or what SSB configuration information is needed in a request and the SSB configuration information is obtained in response to the request. In one embodiment, the SSB transmission and the at least one PRS symbol are mapped to a subcarrier that is not currently being used by the wireless device for mobility measurements (e.g., for subcarriers that are currently used for mobility measurements the wireless device may be assumed to already be configured with at least some SSB configuration information).

In step 1206, the wireless device determines, based on the obtained PRS and SSB configuration information, whether at least one of the PRS symbols collides with the SSB transmission. For example, as explained further above, the at least one PRS symbol may be deemed to collide with the SSB transmission when a resource element mapped to by the at least one PRS symbol at least partially overlaps in time or is separated in time by less than a threshold amount from a resource element mapped to by the SSB transmission. In step 1208, the wireless device adapts its receive circuitry to receive the SSB transmission if the at least one PRS symbol collides with the SSB transmission.

Steps 1210 and 1212 are optional steps of method 1200. In step 1210, the wireless device obtains a positioning measurement using the SSB transmission. In step 1212, the wireless device reports the positioning measurement to a base station or a location server.

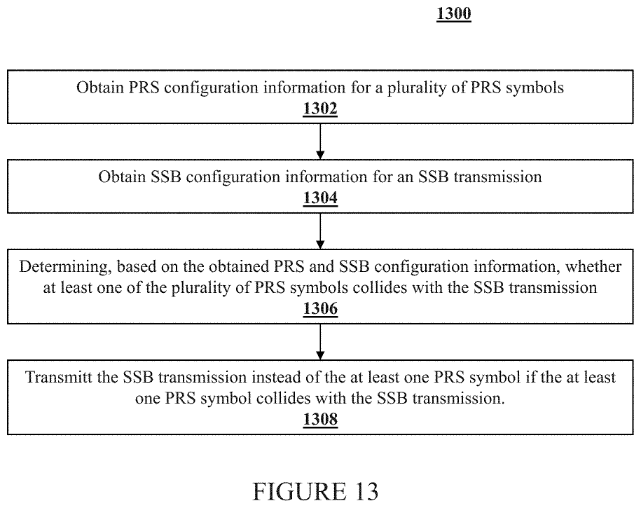

FIG. 13 is a flowchart illustrating an example method 1300 of operating a base station (e.g., wireless device 110, 300) in a wireless communication network 100. The method 1300 comprises a step 1302 in which the base station obtains PRS configuration information for a plurality of PRS symbols. In one embodiment, the PRS configuration information defines a region in which the plurality of PRS symbols are to be transmitted by a base station (e.g., as explained above with reference to FIG. 10). Alternatively (or in addition), the PRS configuration information defines a region in which the plurality of PRS symbols are not to be transmitted by the base station.

In step 1304, the base station obtains SSB configuration information for an SSB transmission. In one embodiment, at least one of the plurality of PRS symbols corresponds to the same cell or base station as the SSB transmission. For example, they may be transmitted by the same cell or base station. Alternatively, the SSB transmission and at least one of the plurality of PRS symbols correspond to different cells. In one embodiment, the base station may obtain the PRS configuration information and/or the SSB configuration information from, e.g., a location server or another base station, in the wireless communication network. In one embodiment, the SSB configuration information includes one or more of a periodicity parameter and an offset parameter. In one embodiment, the base station obtains and transmits the SSB configuration information in response to a request transmitted from the wireless device, the request indicating whether and/or what SSB configuration information is needed by the wireless device. In one embodiment, the SSB transmission and the at least one PRS symbol are mapped to a subcarrier that is not currently being used by the wireless device for mobility measurements.

Next, in step 1306, the base station determines, based on the obtained PRS and SSB configuration information, whether at least one of the PRS symbols collides with the SSB transmission. For example, as explained further above, the at least one PRS symbol may be deemed to collide with the SSB transmission when a resource element mapped to by the at least one PRS symbol at least partially overlaps in time or is separated in time by less than a threshold amount from a resource element mapped to by the SSB transmission. In step 1308, the base station transmits the SSB transmission instead of the at least one PRS symbol if the at least one PRS symbol collides with the SSB transmission.

As described above, the exemplary embodiments provide both a method and corresponding apparatus consisting of various modules providing functionality for performing the steps of the method. The modules may be implemented as hardware (embodied in one or more chips including an integrated circuit such as an application specific integrated circuit), or may be implemented as software or firmware for execution by a processor. In particular, in the case of firmware or software, the exemplary embodiments can be provided as a computer program product including a computer readable storage medium embodying computer program code (i.e., software or firmware) thereon for execution by the computer processor. The computer readable storage medium may be non-transitory (e.g., magnetic disks; optical disks; read only memory; flash memory devices; phase-change memory) or transitory (e.g., electrical, optical, acoustical or other forms of propagated signals-such as carrier waves, infrared signals, digital signals, etc.). The coupling of a processor and other components is typically through one or more busses or bridges (also termed bus controllers). The storage device and signals carrying digital traffic respectively represent one or more non-transitory or transitory computer readable storage medium. Thus, the storage device of a given electronic device typically stores code and/or data for execution on the set of one or more processors of that electronic device such as a controller.

Although the embodiments and its advantages have been described in detail, it should be understood that various changes, substitutions, and alterations can be made herein without departing from the spirit and scope thereof as defined by the appended claims. For example, many of the features and functions discussed above can be implemented in software, hardware, or firmware, or a combination thereof. Also, many of the features, functions, and steps of operating the same may be reordered, omitted, added, etc., and still fall within the broad scope of the various embodiments.

Moreover, the scope of the various embodiments is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized as well. Accordingly, the appended claims are intended to include within their scope such processes, machines, manufacture, compositions of matter, means, methods, or steps.

1. A method in a wireless device for operating the wireless device in a wireless communications network, the method comprising the steps of:
obtaining PRS configuration information for a plurality of PRS symbols;
obtaining SSB configuration information for an SSB transmission;
determining, based on the obtained PRS and SSB configuration information, whether at least one of the plurality of PRS symbols collides with the SSB transmission; and
adapting receive circuitry of the wireless device to receive the SSB transmission if the at least one PRS symbol collides with the SSB transmission.

2. The method recited in claim 1, wherein at least one of the plurality of PRS symbols corresponds to the same cell as the SSB transmission.

3. The method recited in claim 1, wherein the SSB transmission and at least one of the plurality of PRS symbols correspond to different cells.

4. The method recited in claim 1, wherein the wireless device obtains at least one of the PRS configuration information and the SSB configuration information from a location server in the wireless communication network.

5. The method recited in claim 1, wherein the wireless device obtains at least one of the PRS configuration information and the SSB configuration information from a base station in the wireless communication network.

6. The method in claim 1, wherein the SSB configuration information includes one or more of a periodicity parameter and an offset parameter.

7. The method in claim 1, further comprising:
obtaining a positioning measurement using the SSB transmission; and
reporting the positioning measurement to a base station or a location server.

8. The method in claim 1, wherein the wireless device determines that the at least one PRS symbol collides with the SSB transmission when a resource element mapped to by the at least one PRS symbol at least partially overlaps in time or is separated in time by less than a threshold amount from a resource element mapped to by the SSB transmission.

9. The method recited in claim 1, wherein the SSB configuration information is obtained in response to a request transmitted from the wireless device to a location server, wherein the request indicates whether and/or what SSB configuration information is needed by the wireless device.

10. The method recited in claim 1, wherein the SSB transmission and the at least one PRS symbol are defined by the SSB and PRS configuration information, respectively, as being mapped to a subcarrier that is not used by the wireless device for mobility measurements.

11. The method recited in claim 1, wherein the PRS configuration information defines a region in which the plurality of PRS symbols are to be transmitted by a base station and/or a region in which the plurality of PRS symbols are not to be transmitted by the base station.

12. A method in a base station of a wireless communications network, said method comprising the steps of:
obtaining PRS configuration information for a plurality of PRS symbols;
obtaining SSB configuration information for an SSB transmission;
determining, based on the obtained PRS and SSB configuration information, whether at least one of the plurality of PRS symbols collides with the SSB transmission; and
transmitting the SSB transmission instead of the at least one PRS symbol if the at least one PRS symbol collides with the SSB transmission.

13. The method recited in claim 12, wherein at least one of the plurality of PRS symbols corresponds to the same cell as the SSB transmission.

14. The method recited in claim 12, wherein the SSB transmission and at least one of the plurality of PRS symbols correspond to different cells.

15. The method recited in claim 12, wherein the base station obtains at least one of the PRS configuration information and the SSB configuration information from a location server in the wireless communication network.

16. The method recited in claim 12, wherein the base station obtains at least one of the PRS configuration information and the SSB configuration information from another base station in the wireless communication network.

17. The method in claim 12, wherein the SSB configuration information includes one or more of a periodicity parameter and an offset parameter.

18. The method in claim 12, further comprising receiving a positioning measurement from a wireless device, wherein the positioning measurement is made using the SSB transmission.

19. The method in claim 12, wherein the at least one PRS symbol is determined to collide with the SSB transmission when a resource element mapped to by the at least one PRS symbol at least partially overlaps in time or is separated in time by less than a threshold amount from a resource element mapped to by the SSB transmission.

20. The method recited in claim 12, wherein the SSB configuration information is obtained and transmitted to a wireless device in response to a request transmitted from the wireless device, wherein the request indicates whether and/or what SSB configuration information is needed by the wireless device.

21. The method recited in claim 12, wherein the SSB transmission and the at least one PRS symbol are transmitted to a wireless device and wherein the SSB transmission and the at least one PRS symbol are defined by the SSB and PRS configuration information, respectively, as being mapped to a subcarrier that is not used by the wireless device for mobility measurements.

22. The method recited in claim 12, wherein the PRS configuration information defines a region in which the plurality of PRS symbols are to be transmitted by the base station and/or a region in which a plurality of PRS symbols are not to be transmitted by the base station.

23. A wireless device for operation in a wireless communication network, the wireless device comprising:
processing circuitry; and
communication circuitry configured to transmit/receive transmissions to/from one or more base stations in the wireless communication network,
wherein the processing circuitry is configured to:
obtain PRS configuration information for a plurality of PRS symbols;
obtain SSB configuration information for an SSB transmission;
determine, based on the obtained PRS and SSB configuration information, whether at least one of the plurality of PRS symbols collides with the SSB transmission; and
adapt the communication circuitry of the wireless device to receive the SSB transmission if the at least one PRS symbol collides with the SSB transmission.

24. A base station for operation in a wireless communication network, the base station comprising:
processing circuitry;
communication circuitry configured to transmit/receive transmissions to/from one or more wireless devices in the wireless communication network,
wherein the processing circuitry is configured to:
obtain PRS configuration information for a plurality of PRS symbols;
obtain SSB configuration information for an SSB transmission;
determine, based on the obtained PRS and SSB configuration information, whether at least one of the plurality of PRS symbols collides with the SSB transmission; and
transmit the SSB transmission instead of the at least one PRS symbol if the at least one PRS symbol collides with the SSB transmission.

25-29. (canceled)
